(19) United States
(12) Patent Application Publication
(10) Pub. No.: US 2007/0254631 A1
(43) Pub. Date: Nov. 1, 2007

(54) Secure Multi-Entity Access to Resources on Mobile Telephones

(75) Inventor: David Spooner, Berkshire (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: Intuwave Limited, Maidenhead (GB)

(21) Appl. No.: 10/578,767

(22) PCT Filed: Nov. 8, 2004
(86) PCT No.: PCT/GB04/04701

§ 371 Date: Mar. 22, 2007

(30) Foreign Application Priority Data
Nov. 6, 2003 (GB) 0325883.7
Dec. 19, 2003 (GB) 0329520.1

(51) Int. Cl. H04M 3/16

(52) U.S. Cl. 455/411

(57) ABSTRACT

Controlling access to a specific resource on a mobile telephone comprises the steps of (a) associating an identity with a permission state, in which an identity is a label applicable to one of several entities on whose behalf the resource could potentially be used and the permission state defines whether or not the resource can actually be used; and (b) allowing use of the resource solely to an entity or entities labelled with an identity associated with a permission state that does permit such use.

### FIELD OF THE INVENTION

The present invention relates to a method for providing secure multi-entity access to resources on a mobile telephone, such as a smartphones, or other kind of voice and data-enabled mobile device.

### DESCRIPTION OF THE PRIOR ART

Smartphones are an emerging class of mobile device that combine mobile voice and data features into a phone-style device together with an operating system that enables new software applications to be installed and run. Current popular smartphone operating systems are Symbian OS, Smartphone 2003 and PalmOS. Operating systems are currently designed as single-user operating systems so are optimized for use by a single user. Further, the mobile industry in general considers that a hierarchical ‘onion skin’ model defining resource access is an adequate picture of mobile device security:

Inside level: User, phone owner

Next level: Operating system/middleware software vendor

Next level: Handset manufacturer

Outside level: Network Operator

This picture means that, for example, if a end-user runs a banking application from Bank A which stores personal information and also information belonging to Bank A (such as access codes to connect to their systems) then that data is accessible to the end-user, but also everyone in layers of the model that are outside of the inside level. If the network operator wants to, it can access all of the end-users data. It also means that if an entity such as a software vendor is trying to sell this device to an enterprise, for them to roll out some company critical system, then the enterprise is forced to either buy into the picture that handset manufacturer and network operators ultimately control that application and its data, or not roll out the application.

From another angle, consider the mobile telephone as a networked computer. There are millions of users out there in cyberspace who are potentially able to connect to applications running on that phone. With the ‘onion skin’ model, there is no grounding provided, no operating system support, no advice given for an application running in the context of multiple incoming connections. How does a telephone decide that user A can do X but user B cannot? Simply put, it must decide itself—each application is on it's own. If the application vendor fails to address the problem, then user B in cyberspace can theoretically run code on the telephone with the same level of privilege as the phone owner—since there is only one onion skin layer that it can operate in.

The upshot of these two factors is (a) organisations will not adopt smartphones since there is no adequate security model, (b) applications do not get written because there is no security support, or (c) end users are scared away from using smartphones after high publicity security scares about lost data or illegitimate use of their phone. Or all three.

What is needed is a security model that reflects both the needs of the enterprise, application developers and end users.

### SUMMARY OF THE INVENTION

In a first aspect, there is a method of controlling access to a specific resource on a mobile telephone; comprising the steps of:

(a) associating an identity with a permission state, in which an identity is a label applicable to one of several entities on whose behalf the resource could potentially be used and the permission state defines whether or not the resource can actually be used; and

(b) allowing use of the resource solely to an entity or entities labelled with an identity associated with a permission state that does permit such use.

Although conceptually similar approaches to access control have been used in the networked PC space, to date no-one has applied this approach to mobile telephones. The reason is that there is an overwhelming assumption that mobile telephones are single user devices; consequently, a skilled implementer working in the mobile telephone area would not normally look at access control techniques deployed to enable multiple entities to access resources on a device—e.g. to enable different end-users to access data or applications on a single PC or server.

The present invention therefore reflects the situation that there are multiple ‘entities’ at work within the telephone. It starts with the fundamental concept of an ‘identity’—a way of referring to a person, a user, an organisation, a piece of code, a server etc—an entity on whose behalf some code is run on the device. Different entities can share an identity, but can also have different identities. Hence, because there are multiple entities at work, multiple identities can also be at work in a smartphone containing a number of applications—the different identities associated with different entities such as phone owner, the operator, the application vendor, the IS manager of the company the owner works for etc. Hence, unlike prior art approaches that assume the mobile telephone is a single user device, the present invention embraces the idea that multiple entities and hence multiple identities are at work and allows the phone to be configured such that each identity has a set of permissions that indicate what it is allowed or not allowed to do.

In an implementation, the method comprises:

(a) a script or other kind of executable code associated with a given entity sending a request to use the specific resource; the script being labelled with an identity or including a secure signature from which an identity can be deduced;

(b) a software component running on the device processing the request and using the identity to determine the applicable permission state associated with the identity for that script or executable code.

The permission state typically includes a permission type and a value; the permission state associated with a given identity can be updated or altered, for example on instructions sent from a computer remote from the mobile telephone.

The term ‘use’ of the resource includes one or more of: access, deployment, alteration or deletion.

The script or other kind of executable code associated with a given entity may be labelled with an additional identity separate from or independent of the identity of the given entity; the additional label identifying the script or code. Traditional security systems like UNIX access control have permissions and a list of users. In UNIX, each process has 3 identities—the owner of the executable, the effective id of the person who is running it, and a saved id for processes that have temporarily switched to some other id. But with this feature of the present invention, when a script/piece of code asks for a permission, 2 identities are presented—the effective id of the person who is running it, and the id of that piece of code. So the code itself has an identity independent of who owns it or runs it. The software component can then use the permission state associated with this additional identity to enable it to determine if the script/code itself is permitted to use the resource, irrespective of whether the given entity is allowed to use the resource.

The script or code can have its identity altered, with the alteration being a result of instructions sent to the telephone from a remote computer. The identity can be altered to an identity associated with a higher or broader permission state only if the script or code has been authenticated to a pre-defined confidence level.

The method can be deployed on the mobile telephone by a component that is not part of the operating system and can therefore be installed onto the telephone without needing to be burnt into the main ROM of the telephone that stores the operating system. This is especially useful as it enables the method to be deployed on mobile telephones that have already shipped.

For optimal security, the component can run in the secure SIM of the mobile telephone. Alternatively, the permission states and their association with different identities can be stored in the SIM, with the component running outside the SIM. This provides a much greater level of security than is possible using just software because a SIM-card hardware token, combined with strong encryption, provides a strong level of authentication. Remote administration of the permission states associated with different identities is possible by sending instructions from a computer remote from the computer.

The component stores in memory, or accesses from memory a list of the permission states associated with different identities. Further, an identity is determined for any script that seeks to access code by an authentication process using a digital signature. The authentication process generates an identity handle that can be transferred as a token; the identity handle has an associated confidence level based on the authentication.

The entity can be any of: an individual end-user; a network operator; a mobile telephone manufacturer; an application developer or vendor; an employer; an operation. Where the entity is an operation, the operation can be booting the telephone so that startup code is run, the startup code having a specific identity, and the permissions for this identity determine what can or cannot be done at startup. Another operation could be a timer going off.

Also, the entity can be a kind or type of entity.

The approach of the present invention is very different from the conventional ‘onion skin’ hierarchical model. Instead, at least two entities do not have identities that are associated with permission states that are hierarchically arranged with respect to each other. In many instances, no entities have identities that are associated with permission states that are hierarchically arranged with respect to each other and no entity automatically has rights to use all resources on the telephone.

The resource can be specific data; the permission state can then determine whether the data can be read, modified or deleted. The resource could instead be a specific executable application and the permission state then determines whether the application can be run or updated. The resource could also be a hardware resource on the telephone, such as a networking or communications resource on the telephone.

In terms of physical interactions with hardware, the step of associating an identity with a permission state results in a record of the association stored in a memory of the telephone. Also, the step of allowing use of the resource takes place by a CPU in the telephone processing data.

In another aspect, there is a mobile telephone with specific resources, in which access to the resources is controlled using the method defined above.

Concept Level Examples

Some examples will assist. Consider a file on the phone containing bank account details. The phone owner runs the banking application which tries to access that data—there are two identities at work there—the owner, and the banking application. Access control is handled by a software component, namely a kernel that is not an integral part of the operating system; this is the ‘mrix kernel’. It can decide that the owner is allowed read only access to the data and that, furthermore, the banking application can also access the data (contrast this with the Space Invaders game an user just downloaded—that most certainly cannot access the banking data—no matter who runs it).

Digital signatures can be used to ascertain that the banking application is what it says it is—i.e. it is not the invaders game in disguise. Now consider Bank A—they want to remotely administrate the banking applications that are rolled out—maybe to change some of the data. They connect to the phone and log in to the banking application administration module. The ‘mrix’ kernel can decide that the bank owns the bank account details and can therefore have read/write access to the file.

As a further example consider now that the user goes to work for Company B as a salesman, and they roll out the Company B sales application onto the user's phone. There are now multiple applications on the phone, multiple sources of data, and multiple owners. The user has his own personal contacts, Company B contacts, Bank A account information and Company B sales figures. No one organisation should have access to all of that. The present invention makes sure that everyone just has access to the information that they should.

A more complex example follows: User Bob gets a banking application from Alice Bank Ltd. The banking application is stored on his phone and uses m-Network. It consists of two scripts, mrBankClient and mrBankAdmin. A note on terminology here: an implementation of the present invention deploys “pipe processors”. These are small stand-alone modules written in C++ or scripting languages that encapsulate a range of smartphone functionality. Device resident mrix pipe processors are prefixed with “mr”.

Bob can run mrBankClient to access his bank account details, view his statements, make payments etc. Alice Bank can remotely run mrBankAdmin to administrate his account, e.g. allow new banking functions, or remove him if he leaves the bank. When the banking application was provisioned to Bob's phone all the necessary identity and permission settings were also provisioned into the kernels identity database (currently a text file called identity.ini). Here are some examples to illustrate how the system works:

Bob runs the mrBankClient script which pops up a simple user interface. By default this is running as a Guest identity. If Bob tries to access banking information then mrBankClient will ask the kernel—is Identity Guest allowed to access bank account data? The kernel will check and reply with the answer NO.

Bob chooses the Logon method in the UI, and is asked to state which identity he is, and to present credentials to back that up. This could be a username and password combination. It could be a biometric indicator such as a fingerprint (identity and credentials in one). The identity and credentials may also just be assumed—this is Bob's phone, and the Bank/Bob trusts that Bob does not lend his phone to anyone else, and if it is stolen then it will be locked. Whatever method the mrBankClient script will ask the kernel to set the current identity to ‘BobIdentity’ with the credentials. The kernel looks up in the identity database and decides whether or not to grant permission. The current identity running the script has now switched from Guest to BobIdentity.

Bob now tries to view his statement. The mrBankClient asks the kernel if BobIdentity is allowed to view statements. The answer is yes and Bob looks at his statement.

Alice Bank decide to give Bob an overdraft. This means that the mrBankClient script will be able to make payments even when Bob's balance has got to zero—currently the permission ‘OverdraftLimit’ for BobIdentity is set to zero. Using a terminal at the bank, an employee of Alice Bank connects to mrBankAdmin service on Bob's phone which causes the mrBankAdmin script to be run. The bank employee presents credentials to mrBankAdmin—probably a username and password again, so now the mrBankAdmin script is running as identity AliceBankIdentity. Alice Banks chooses the ‘add overdraft’ option. The mrBankAdnin script now needs to update permissions for BobIdentity. So mrBankAdmin asks the kernel to change the OverdraftLimit permission for user BobIdentity from 0 to 500. When it does this it passes in the identity of the current user—AliceBankIdentity—and also it's own identity mrBankAdminIdentity. The authenticity of mrBankIdentity is assured by the fact that the mrBankAdmin script is signed with a signature that corresponds to mrBankAdminIdentity. The kernel must now decide whether the request is allowed. It looks up first in the identity database to ask ‘Does the AliceBankAdminIdentity have permission to alter the permissions of BobIdentity?’ secondly it will ask the same question of mrBankAdminIdentity—i.e. is that script allowed to do that, irrespective of who is running it? All is well since the required permissions have been set in advance and the overdraft is granted and Bob can go on a spending spree.

Finally—Betty secretly accesses Bob's phone and alters mrBankClient script maliciously so that running it will execute a viral program when the phone is booted. Bob does not realise and runs the altered mrBankClient script as normal. Betty's code is executed which requests to use mrEvent to add a new command to the BOOT event. This request is run on behalf of Bob since Bob has logged in properly to the application. All is not lost however. mrBankClient script executes mrEvent, so mrEvent checks whether BobIdentity and the script identity have permission to change events at boot. The script identity is not presented as mrBankClientIdentity, since the script has been altered and so the signature cannot be verified. Instead the script is presented as Guest. Luckily the permissions for mrEvent around setting boot events have been set sensibly so that no matter who runs the command, it can only succeed if the authenticity of the running code can be established—i.e. untampered versions of mrFile, rshd (this is a command interpreter module, and is normally set up to start up on boot) or user scripts would succeed, but not tampered versions.

### BRIEF DESCRIPTION OF THE DRAWINGS

The invention will be described with reference to the accompanying drawings, in which:

FIG. 1 is an example configuration of a system (‘mrix’) for rapid application development that provides for secure multi-entity access to resources on mobile devices;

FIG. 2 shows a possible mrix architecture for an implementation of the present invention;

FIG. 3 shows how mrix consists of a number of elements which can be used to run commands over local links (IR, Bluetooth and USB) as well as via a remote relay (TCP/IP, GPRS);

FIG. 4 shows the class structure of the mrix kernel;

FIG. 5 shows a portion of the FIG. 4 class structure;

FIG. 6 shows a matrix of separate policy/permission stores;

FIG. 7 is a class diagram for the MrixKernelTasks.dll;

FIG. 8 shows a class diagram for MrixKernel.dll.

### DETAILED DESCRIPTION

A.1 Overview of mrix

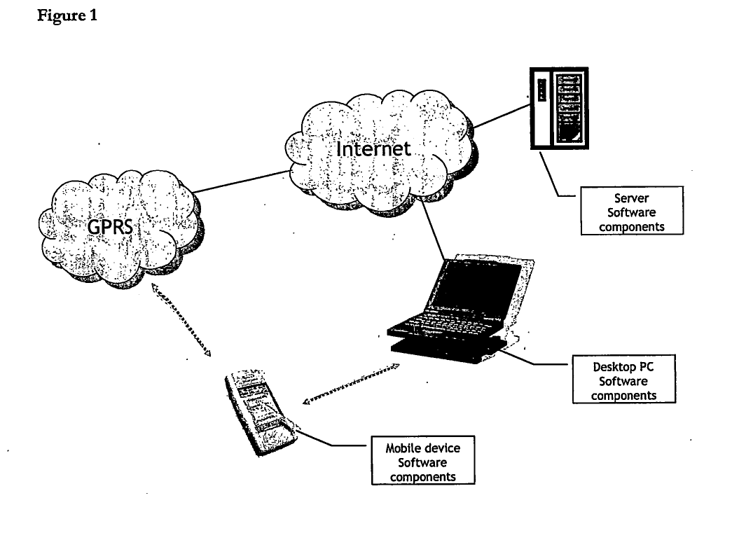

The present invention is implemented using a software called ‘mrix’ from Intuwave Limited. mrix facilitates the rapid develop of networked application software for mobile devices and provides for secure multi-entity access to resources on such devices. An implementation comprises software resident on the different computing devices connected to the network, including mobile device, such as a smartphone, desktop PC and server, with an example configuration shown in FIG. 1.

Software components are required on all of the different elements in the network to facilitate rapid application development and deployment. This is illustrated by the following example for developing a networked application on the mobile device that enables a user to make full use of an enterprise CRM system for better customer relationships. To do this, software must be developed on the mobile device that can connect to an enterprise server, that implements the CRM system and manages all of the customer interactions for the enterprise. The mobile device must be able to connect both over a wide area connection to the server (such as over GPRS) as well as through a faster local connection through a broadband wireless link through the PC. The limited user interface of the mobile device also means that the mobile device must connect easily with the desktop PC to allow the user to take advantage of the large screen and keyboard of the desktop PC when the user is sitting at his or her desk.

The traditional means of developing such an application would be to develop the software on the desktop PC using appropriate development tools, such as an IDE, and to run and test the application on an emulator on the desktop PC. Once the software is successfully running on the emulator then it can be transferred to the mobile device, where it needs to be debugged again. This approach is often fine for non-networked application as there is little difference between the emulator and PC. However, for networked applications the emulator does not have the range of network connections available on the mobile device so development is much more difficult. This problem is overcome in mrix by having components on the desktop PC (which term includes Windows, Macintosh, Linux or any other operating system powered computers) and mobile device that can be executed over the network connection, either locally over a local wireless link, such as Bluetooth, or remotely over GPRS (or any other connection to the phone such as SMS). Hence, the developer can proceed in a much faster way for development of the networked application as follows:
1. The developer chooses which of the modular set of mrix pipe processor components will be used for the application.
2. The developer tests how the chosen pipe processors will be used from the command line.
3. A simple script can be put together to put these together into a complete application running on the phone, again running remotely from the desktop PC.
4. Connectivity components on the PC, such as mRouter, which may be part of mrix, are used if networked connectivity is required to, or routing through, the desktop PC from the mobile device. See PCT//GB2002/003923, the contents of which are incorporated by reference, for more details on mRouter.
5. Connectivity components on the server are used if the server needs to connect to the phone. This is required as the phone's IP address is not visible to the outside world so cannot be contacted by the server. Hence, the Relay server is required that is visible by both the phone and back-office server, to enable networked communication to the server.

mrix is a wireless software platform designed to significantly reduce the time to market in producing solutions involving smartphones by:—
reducing the learning curve and therefore opening up development to a larger community of developers
providing network OS like facilities allowing smartphones to be treated like shared network components
providing critical “building blocks” which encapsulate complex smartphone functionality.

mrix includes a platform agnostic remote command execution environment for smartphones. A command interpreter interfaces to a smartphone through a set of commands or “pipe processors”. These are small stand-alone modules written in C++ or scripting languages that encapsulate a range of smartphone functionality. Device resident mrix pipe processors (prefixed with “mr”) are provided which facilitate the control and management of multiple bearers (GPRS, SMS, Bluetooth, MMS, WiFi etc); device peripheral (such as barcode readers, pens, printers, GPS etc); other devices and servers; and network billing. Pipe processors can be “chained” together to build more functionality. These building blocks allow fast and iterative development of mobile solutions. The use of scripting languages opens up development to a much broader community of developers.

A2. mrix Architecture

mrix is designed around a command interpreter running on a smartphone and a command execution shell running on a remote PC or other suitable platform. Pipe processors can be invoked remotely (like Unix commands) from a desktop PC via m-Router™ or a remote server via a Relay. This not only allows development and debugging of an mrix solution to be carried out from the convenience of a desktop PC but also allows smartphone components to be shared at runtime over networks.

Some pipe processors are mandatory and are considered core to the system. Examples include mrEvent or mrAt which are used to start and stop processes based on events. A set of optional pipe processors are also supplied which can be removed from the runtime, if required, to minimise the memory footprint Custom pipe processors can also be built in C++ or LUA Script and templates are provided for this.

A.3 mrix Solution Examples

See “mrix Features at a Glance” for more information on components used.

Monitoring Spare Parts Availability

| | |
|---|---|
| Description | Keeping an accurate inventory of the levels |
| | of spare parts carried by a field engineer |
| | is difficult. By combining low cost Blue- |
| | tooth peripherals such as pen barcode |
| | readers with the advanced connectivity |
| | features of smartphones, mrix enables |
| | field service engineers to keep a tab |
| | on van stock levels and automatically |
| | enquire if missing stock items can be |
| | picked up from other vans in the area. |
| mrix Solution | mrBluetooth is used to easily manage the |
| | connectivity between a smartphone and a |
| | bluetooth enabled barcode pen. When the |
| | engineer needs a part, he/she |
| | “swipes” the product barcode |
| | from a parts catalogue. A persistent |
| | inventory of parts is maintained on the |
| | device using mrStorage. Automatically, |
| | the smartphone indicates to the engineer |
| | the available stock on the van. If the |
| | part is not available, an SMS is created |
| | via mrMessage and sent to other engineer's |
| | smartphones. Using mrWatchFile on the |
| | recipient's smartphones to trigger on |
| | receipt of a specific SMS message, the |
| | inbound SMS causes an inventory check to |
| | be carried out. If the remote engineer's |
| | phone indicates that the part is available |
| | on the van, an SMS is automatically sent |
| | back to the original engineer. On receipt |
| | of the SMS, a prompt automatically |
| | displays on the smartphone (mrPrompt) |
| | which informs the engineer that the part |
| | is available and supplies the phone number |
| | of the engineer with that part. The |
| | process can be further enhanced to only |
| | inquire of stock availability from |
| | engineers who are local using mrSim and |
| | the current cell-id. |
| Components | Relay, mrBluetooth, mrStorage, mrMessage, |
| Used | mrWatchfire, MrPrompt, mrSim |

Sending an SMS from a PC

| | |
|---|---|
| Description | Entering text messages can be tedious |
| | on a small smartphone. With mrix on the |
| | device, it is straightforward to build |
| | an application which would allow text |
| | messages to be composed from a Bluetooth |
| | connected PC and sent via the phone. |
| mrix Solution | Using m-Router and mrCmd, the smartphone |
| | is connected to the PC via Bluetooth. |
| | After authentication of the user |
| | (identities), a list of contact names |
| | and phone numbers is retrieved from the |
| | phone (mrContacts) and displayed on the |
| | PC. The user selects one or more contacts |
| | on the PC, enters the body of the text |
| | message and presses “Send SMS”. |
| | PC application calls mrMessage with the |
| | data and the text message is |
| | automatically sent from the phone. |
| Components | m-Router, mrCmd, Identities, mrContacts, |
| Used | mrMessage |

Remote Smartphone Support

| | |
|---|---|
| Description | Providing support to remote smartphone |
| | users can be a problem. mrix allows an |
| | operator with a remote PC (and |
| | permission from the end user) to take |
| | full control of a smartphone connected |
| | over a cellular network. |
| mrix Solution | The end user runs a support application |
| | on the smartphone which automatically |
| | connects to a network hosted Relay over |
| | the cellular network. The operator also |
| | connects to the Relay via an application |
| | on their PC. Once all parties are |
| | connected, the operator can connect |
| | directly to the smartphone. Using |
| | mrKeyboard and mrImage, a real-time |
| | moving image of the smartphone's screen |
| | and a working visual image of the |
| | smartphone's keypad are displayed on the |
| | operator's screen. Using mrPrompt, the |
| | operator is able to ask the user for |
| | permission to carry out certain tasks on |
| | the device. Using mrPS, the operator is |
| | able to see a list of the applications |
| | currently running on the smartphone. |
| | Using mrLaunch and mrShutdown, the |
| | operator is able to start and stop |
| | running processes and restart the phone |
| | remotely. Using mrSysInfo, the operator |
| | is able to see information about the |
| | smartphone including available memory, |
| | storage types etc. All tasks are |
| | completed remotely with the user |
| | involved throughout the operation. |
| Components | Relay, Identities, mrKeyboard, mrImage, |
| Used | mrPrompt |

mrix Features at a Glance

| Need | Feature | Benefit |
|---|---|---|
| PC Connectivity | m-Router ™ | Provides IP over serial link. Allows full |
| | mrCmd | control of device from connected PC over |
| | | Bluetooth, IrDA, cable etc. |
| Operation over | Relay | Connects devices and server processes over |
| remote connection | | firewall protected networks where devices |
| (GPRS, WiFi etc) | | are not “visible”. Allows device on GPRS |
| | | network to be discovered by other devices |
| | | or services and facilitates “push”. |
| Security | Identities | Users (or services) have to supply |
| | | credentials to access commands on the |
| | | device. |
| Data Storage | Sky Drive (remote) | Important data captured at the smartphone |
| | mrStorage (local) | can be sent to an always available virtual |
| | | storage device on the network or in the |
| | | device. Data stored can be processed at a |
| | | later time. |
| Messaging | mrMessage | Easy to monitor and manage the device's |
| | | message centre. |
| Event Driven | mrWatchfire, mrAt, | Trigger actions when certain situations are |
| Operation | mrEvent | met. E.g. run script on receipt of specific |
| | | SMS/MMS message. Also schedule |
| | | operations to run at specified times. |
| Connectivity | mrBluetooth, | Create and manage connections over |
| | mrObex, mrTCP, | multiple bearers, examine and process data |
| | mrThroughput | sent and received and measure network |
| | | performance. Send files via OBEX. |
| Phone Information | mrSysInfo | Returns device information including |
| | | available drives, free space, format etc. |
| Network | mrSIM | Returns network information such as IMEI, |
| Information | | current cell-ID, area and Mobile Network |
| | | Operator. |
| Remote Control | mrImage, | Allow device screen to be projected to a |
| | mrKeyboard | connected PC and the keyboard of the |
| | | smartphone to be controlled remotely. |
| File Manipulation | mrFile | Easily manipulate the smartphone file |
| | | system. |
| Runtime Control | mrPs, mrMr, | Query, start and stop processes on the |
| | mrBoot, | smartphone; start applications automatically |
| | mrShutdown, | on boot and shut down a device. |
| | mrLaunch | |
| Data Capture | mrPrompt | Capture data from the user on smartphone |
| | | via pop up dialog box. |
| PIM Data Access | mrContacts, | Full search, add, edit and delete of |
| | mrAgenda | smartphone PIM data including contacts, |
| | | calendar and memos. Possible to manipulate |
| | | vcards, minivcards, uuids, speed dials, |
| | | groups etc. |

Specifications

| | | |
|---|---|---|
| Supported | Smartphone | Symbian OS v6.1, 7.0, 7.0 s |
| Operating Systems | | Microsoft PocketPC Smartphone Edition |

| | |
|---|---|
| Relay, mrCmd | MacOS X, Linux, Windows ME, 2000, XP Home and |
| | Professional |

A.4 Feature List

The core mrix system contains a number of elements some of which are deployed on the smartphone:

mrcmd: mrcmd consists of two elements, a command interpreter for smartphones and a remote command execution shell. The command interpreter currently runs on Symbian. The remote command execution shell runs on Windows, Mac OS X and Linux.

m-Router®: Command-line interface to Intuwave's existing m-Router® product which handles local connection management on Symbian OS smartphones. m-Router® operates over Serial, Bluetooth, USB and IrDA bearers.

mrElay: mrElay consists of both a command-line interface to Intuwave's remote relay server and the relay server itself. Currently the relay server can be accessed from the smartphone via GPRS or via a WAN proxied through a local m-Router® link.

pipe processors: Pipe processors are small self-contained modules that encapsulate smartphone functionality. A small number of pipe processors that manage event handling and file access are in the mrix core.

script engine: A powerful and compact (60 k) LUA 5.0 scripting engine is included on the smartphone to allow a developer to readily combine pipe processor functionality directly using scripts. Included with the scripting engine are a number of core mrix scripts that powerfully combine existing pipe processor functionality.

mrix Reference Manual: HTML pages that explains how to use all the existing core pipe processors. There are also instructions on writing new pipe processors as well as m-Router® and mrcmd functionality. documentation and example scripts detailing is included.

We have a range of additional pipe processors that extend the core functionality of the system. These pipe processors can be readily added to an mrix system to enhance its capabilities.

A.5 Areas of Application

mrix technology is directly applicable in a wide range of applications where remote control of a smartphone device is important:

Testing: mrix enables full automation of system, functional, acceptance, regression and interoperability tests.

PIM applications: mrix enables rapid development of PC Connectivity PIM applications through script-accessible toolkits.

Access control: mrix enables secure multi entity access to resources

A.6 Benefits

mrix offers numerous benefits to smartphone manufacturers and phone network operators.

Speed of development: mrix development is done in rapid iterations by evolving scripts rather than coding against APIs. This significantly speeds up the development lifecycle.

Cost: Since mrix functionality is script-based, the cost of development as well as the cost of maintenance and enhancement of functionality is significantly reduced.

Cross-platform: mrix offers full cross-platform support for smartphones. When combined with a cross-platform toolkit, server applications can be built to run across different PC Operating Systems.

B. Security—Principles and Philosophy

The security in mrix is modelled around real life. In real life everyone, everything operates as an identity. Examining a banking example in more detail is useful in understanding the way security works in mrix. The names and scenarios are blatantly contrived but they serve to illustrate important points.

Imagine an individual “Alice” (A) enters “Bob Bank International” (B) and queues for cashier “Charlotte” (C). Alice then pays in or withdraws some cash. This appears a simple transaction, but an individual “Eve” may and try and steal money from Alice or the bank. Consider the methods Eve might use. They might attempt to impersonate Alice and withdraw fund from the bank, or to impersonate Charlotte at a fake bank, or to in fact get a job at the bank and as charlotte defraud the bank. There may also be brute force attacks where Eve attacks Alice outside the bank, or attempts to hold up the bank with a gun.

Consider an analogous scenario where Alice (A) accesses the contacts on bobs phone (B) and uses mrContacts (C) to add or retrieve contacts. Consider that “Eve” may try and view or corrupt the contacts. They may try and impersonate Alice and use bobs phone, or give Alice a pretend phone so as to get her to enter the contact. They may even try and install software on bobs phone that acts as mrContacts and thus can behave maliciously. There may also be brute force attacks on Alice or on the physical hardware of Bob's phone.

While a callous statement, in both cases the physical protection of Alice is her own problem and outside the scope of any protection in/of the bank/phone. Likewise the physical protection of the bank building/safe and of the physical memory of the phone is a problem under the realm of the architect of the building/chips. As with all security and all things, there is no perfect answer and no total security, just degrees of confidence.

This leaves us with a few important points common to both examples that we can try to address.
We want to bc able to prove that Alice is who she claims to be
We want to ensure that the cashier/mrContacts is trustworthy
We want to ensure it is the intended bank/phone and not an imitation
We want to ensure that transactions between Alice and the cashier/mrContacts cannot be eavesdropped and later used to commit fraudulent access.
We want to ensure that this not to complicated else the bank/phone will not be used.

The is also an example where a person who isn't a customer of the bank/phone wants to do something, maybe change some coins or check a public contact. Obviously in this case we don't need to authenticate the user, we CANT since we have no prior relationship. Also we want to be able to allow the guest to do some things and not others.

With a bank auditing is important, to show when money was deposited or removed and to check who authorised/performed the transactions. Likewise on a phone there may be a desire to record which operations are performed, when and by whom, for billing, diagnostics, or purely interest.

Consider for a moment Alice proving who she is. You can just provide her with a pin code or a secret password and ask her to quote this each time she is uses the bank or phone. This relies on eve not guessing the password or over hearing it. With online banking a common solution is to give a longer pin code and to only ask for a subset of digits. By asking for a different subset each time, eve has to eavesdrop more transactions to discover the entire secret. Alternatively one could use Alice's signature. But what if eve makes a photo copy of the signature? In that care its safer to have Alice sign something in front of the cashier and then compare it to a trusted copy. Using public private key technology its possible for Alice to encrypt arbitrary data with her secret key and then give the encrypted data to the phone together with her public key. Since only the public key can decrypt the data, the phone can reasonably assume that the encryptor is Alice. By generating unique data to encrypt, the phone can ensure eve cannot capture and re-use the signed data for her own nefarious schemes. Of course all this guarantees is that Alice has the corresponding private key. The bank then recognizes Alice on repeated visits if she uses the same signature each time. In order to prove that this signature corresponds to a person in the real world the bank needs some proof of identity such as a driver's license or a passport. Likewise a digital signature allows the phone to know a user is the same user as ‘last time’. In order to link this signature to a real world identity it needs to be supported by a certificate from another trusted entry. Such a scheme has to rely on at least one trusted root entry.

How does Alice know she can trust the cashier? Firstly she has to trust that the bank is careful as to who it employs and gives access to its resources. Alice has to trust that the bank checks each morning that charlotte the cashier is who she claims to be. Alice knows that most bank systems don't let charlotte see all of Alice's secrets. Charlotte sits at a terminal that may display questions to ask Alice, and charlotte may enter the answers, but typically charlotte will not see all the secrets, just the subset used to authenticate Alice. This means charlotte doesn't need to be an expert in authentication she just needs to ask the questions on behalf of the banking systems and to enter Alice's responses. Back in the land of mrix one doesn't want to reproduce complex cryptography and authentication code in each module. Rather modules such as rshd or mrBluetooth can ask questions on behalf of a trusted security module, pass Alice's responses back to this secure module and if successful obtain a abstract token, an identity. The bank would not wish ever cashier to know all the permissions and information about all its customers. Typically after authentication it allows a cashier to view a subset of the information for that customer. The cashier cannot access every scrap of information, just what is relevant to the task at hand, likewise charlotte the cashier cannot access the information or an arbitrary user, JUST the user that has been authenticated. There may be different ways of authenticating Alice, and this step is clearly separate but sequential with actually taking advantage of Alice's identity. In mrix each component CAN use the core security module to challenge the user and get an abstract identity module. Using that module mrContacts or any module can query the system for per identity policy and permissions. Finally the system only loads modules and command that it ‘trusts’.

C. Target System

This section describes the target security in mrix. It is written in the present tense though gone of what it describes may not yet exist. A separate document describes the current state of affairs.

C.1 Underlying Implementation

The core of mrix is based on
mSecure—this single EPOC server combines the functionality of mStream/mIdentity/mrBoot and in doing so offers greater security and functionality with less overhead. For example where as it took at least 12 calls to 2 different servers previously to request a pipe processor it now only takes 2 calls.
   Various wrapper/helper libraries layered over these core systems
   C.2 Identities

mrix security is based on the concept of identities. Identities are an abstract concept similar to user id's or principles. Pipe processors are invoked on behalf of an identity and thus can behave differently according to which identity it is. Identities are represented in the system by identity handles (tokens) which can be passed between modules and processes if so desired. Identity handles can only be created as a result of an authentication process. Given an identity a module can query for permissions and other settings for that user. In addition to the identity invoking a module there is also a second identity available to modules, that being the identity that created/authored/signed that module.

C.3 Pipe Processor Meta-Data

Each pipe processor (including but not limited to scripts) can be supplied with a separate meta data file. This file itself is signed and so modifications to the meta data can be detected. The meta data includes
A hash of the pipe processor the file corresponds to
Copyright, Version, Licence and author contact information Permissions and modules required by the pipe processor (ie dependencies)
Permissions embedded in the pipe processor (ie policy)

The contents of the file is initially created as a text document by the author and then signed/compiled by the txt2mrix utility.

C.4 Authentication

mrix provides several types of authentication including private/public key, plain text and hashed authentications. Such credentials are stored encrypted on the device memory. The encryption may be further enhanced in some configurations through the collaboration with trusted hardware (ie a SIM card)

Rshd challenge the remote peer running mrCmd so as to authenticate the user. The form of the authentication is negotiated between the server and the peer.

Authentication mechanisms include
Plaintext username/password—simple but secrets may be in plain sight
MD5 hash of username/password and challenge—Each time an authentication is needed a unique key is used as a challenge. An algorithm is used to generate a hash from this key, and a secret known only to the trusted entities. Both ends perform the same has algorithm, if the transmitted result is the same as the expected response then it follows the peer must know the secret. By transmitting the hash the secret need never be revealed over an unsecured link, by using a unique key each time previous responses cannot be used in subsequent fraudulent authentications.
Public/private keys—on their own public private keys can be used to prove that the peer is a holder of a private key. Certificates can be used to link that ownership to a real world identity. By taking a document and creating a hash of it, and then encoding that hash with a private key a document can be signed. Changing the document changes the hash and thus invalidates the signature. mSecure uses this property to sign files, and consequently allows scripts to be executed with a selected identity without the need to embed plain text credentials in the script itself.
   C.5 Permissions and Policies

mSecure provides encrypted storage facilities for each identity it manages. Since pipe processors can be signed/authored with identities this means each pipe processor ‘can’ have access to its own secure private storage. Within that storage mSecure offers per identity sub-storage. For example mSecure provides storage to the identity of the ‘mrFile’ pipe processor. mrFile can store permissions and policy data in this storage such that no other identity can access this data. With that storage space mrFile can store separate data for the identities “John Doe” and “Anie Won”. mrFile can this check the ‘settings/permissions’ for ‘JohnDoe’. If a script is signed with the mrFile identity then it can access this storage. This means scripts can be used as part or administration and configuration for pipe processor permissions and policies. The data that can be stored in this encrypted storage is a hierarchal name value structure. Each name value pair can store a different value for each identity. A comparison might be made with a source control system where there are folders and sub files. Each file in addition may have various versions. The name value pairs are Unicode text. The storage does NOT support raw binary data.

When identities are removed from the system, for example when pipe processors are uninstalled the associated storage can be automatically deleted. The storages are persisted in the file system in an encrypted form. The encryption of these files can be further protected by using keys which themselves are kept in secure hardware. If this is done then even if the file system is subverted and the data transferred to a different device the absence of the secure hardware (ie a sim card) means the data cannot be read.

With this level of system support the core pipe processors allow fine grain control over their behaviour. For example mrFile allows read/write access control to different areas of the file system.

C.6 UI for User Configuration

In order to manage the identities and associated data on a device mrix includes a user interface component called mrixConfig. This user interface allows the following
Addition/Removal of (user) identities with arbitrary authentication data.
Addition/Removal of scripts and pipe processors (themselves identities)
Granting and revocation of permissions and policies for the above

It should come as no surprise that the user must authenticate themselves before they are able to use the user configuration tool. This allows for shared use of a mobile phone for both personal and corporate use. Ie if the phone is purchased by an individual they may grant a subset of their permissions to a corporate IT identity that can be used to install and remove corporate applications and data. Whether the individual can later administer these corporate apps and data is up to the ‘contract’ between the individual and the corporation. Mrix allows a range of options to be selected. In this case the individual always has the choice of purging such applications and data from their phone if they so whish. Alternatively a corporate may own and issue a mobile device to an employee and grant them permissions to install and run personal applications. Again while this data is private to the individual the corporate may purge it if they wish—as they were the granter of permissions to the individual in the first place. Such sharing of the phone allows an identity to grant and delegate permissions to other entities. Typically there might be some financial agreement in place for this sharing but this is outside the scope of mrix at this time. That said the facilities provided by mrix can be used to implement chargeable services.

C.7 Installation—Mrix Core

The mrix core may be burnt into rom or installed as an additional component after a phone is purchased. Initially mrix uses an identity called ‘factory default’. This identity may be used to create additional user identities to administer the phone. Such as corporate IT department and sony online gaming etc.

C.8 Installation—3^{rd} Party

File locations for installation are as for the mrix core. Note however that the Identity.ini file needs to be modified for each new pipe processor dll. Scripts currently do not have ‘allow’ permissions and so all scripts can be invoked by anyone. The behaviour of such invocations is obviously subject to the behaviour of the pipe processors it uses, in turn dependant on the identity used by the script. Other that running or examination a script there is no practical way of telling if a script will execute as expected for a given identity. Finally any user can install any pipe processor on their phone regardless of licensing on the pipe processor or ownership of the phone. (ie a phone supplied to an individual by their employee for business use)

Appendix 1

MRIX—Getting Started Guide

1.1 MRIX Overview

mrix is a platform agnostic wireless network operating system. It is designed to allow rapid cross-platform development of a wide range of mobile applications both on and between smartphones, personal computers and servers. It consists of a powerful set of command-line driven tools which can be built upon and combined into sophisticated PC applications using scripting languages. In addition, mrix can be used to script applications that can be executed on the smartphone itself.

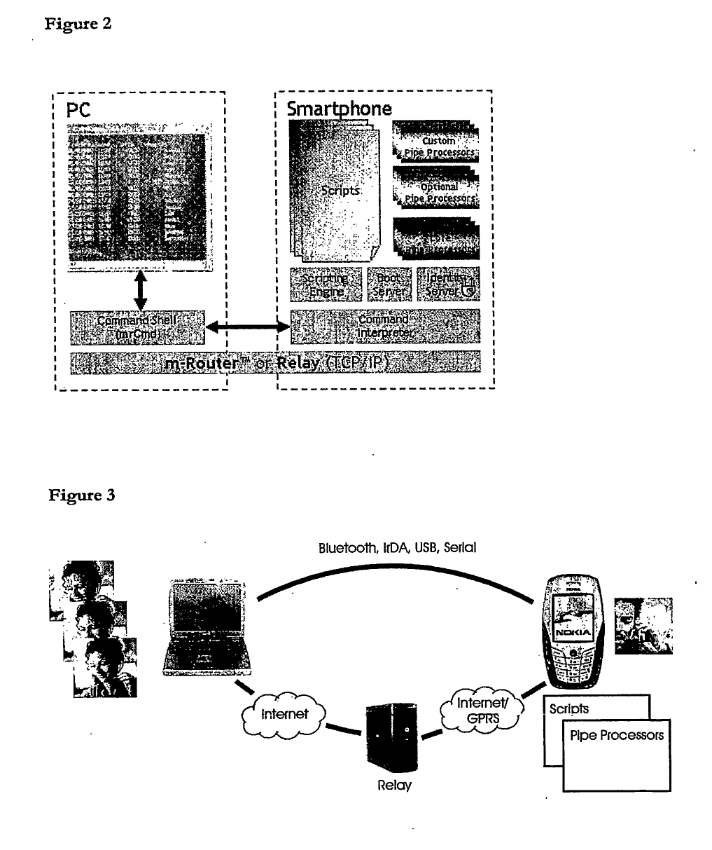

FIG. 2 shows a possible mrix architecture.

mrix consists of a number of elements which can be used to run commands over local links (IR, Bluetooth and USB) as well as via a remote relay (TCP/IP, GPRS) as illustrated in Error! Reference source not found.

There are several key elements of the architecture:
m-Router: Bearer connection agent. m-Router consists of a number of both PC and smartphone components. It enables communication between a smartphone and a PC over a variety of short-link bearers: IrDA, Bluetooth, USB and Serial.
Relay: The relay, mrElayD (the ‘D’ stands for daemon) allows remote access from a PC to a smartphone via GPRS. The PC and smartphone both connect to the relay in order for communication between them to occur.
Identity server: All commands are run, whether locally or remotely, on behalf of an “identify” (person or system). Different identities may be configured to run commands with different results.
Boot server: Handles mrix events to be started on smartphone reboot.
Command interpreter: A command interpreter module, rshd, runs on the smartphone and is normally set up to start up on boot
Command shell: A command shell, mrcmd, runs on the PC. The shell currently runs on Windows but will soon be available on Linux and Mac OS X. Programs and scripts can be written for the PC that communicate and interact with mrix components on the smartphone.
Lua scripting engine: Scripts written in Lua (http://www.lua.org) can be run on a smartphone. A number of useful scripts, e.g., SMTP and FTP clients, are provided with the release.
Pipe processors: Discrete smartphone modules that can be accessed through the mrix command environment to provide access to a range of smartphone functionality.
   1.2 Prerequisites

Usage of mrix requires the following hardware and software:
PC with IrDA or Bluetooth support
Microsoft Windows 2000 or later
m-Router
mrix
Smartphone (Nokia 7650, 3650, 6600, N-Gage, SonyEricsson P800)
   1.3 Using MRIX
   1.3.1 m-Router—Connecting to the Smartphone

On the PC open a command prompt and type
>mrouter -h

This command displays the help for m-Router. All commands have a help option that can be invoked via -h or the long form --help.

To search for smartphones to connect to type
>mrouter -c search-devices

This command option searches for all the Bluetooth devices in the locality.

The first four columns listed are an arbitrary ordinal listing number used to represent the device, the UID (for smartphone devices this will be the IMEI number—in this example it is only shown for device 8), the Bluetooth address and the Bluetooth friendly name (assigned by the user of the device).

Find your smartphone from the resulting list of devices then connect to the smartphone by typing the following command at the command prompt
>mrouter -c connect-device -d<Bluetooth device name>

For example if your smartphone has a Bluetooth name of Nokia7650 then the command would be
>mrouter -c connect-device -d Nokia7650

You will see the seen of the m-Router icon in the system tray turn from red to blue. You may find that for development purposes using the ordinal resulting from the “search-devices” is the most convenient. You can connect to a smartphone using a variety of addressing schemes. The “-d” option takes the form <schema>:<id>. Schema can be one of N, IMEI, BTADDR, BTNAME, ANY. If not present, schema is assumed to be ANY. N will match against the listing number next to each device returned by list-devices or search-devices. IMEI matches the UID field. BTADDR matches Bluetooth address. BTNAME matches device BT friendly name. ANY matches all the above. So, it is possible to connect to a device in various ways thus:

>mrouter -c connect-device -d 8
>mrouter -c connect-device -d IMEI :xxxxxxxxxxx
>mrouter -c connect-device -d BTADDR :xxxxxxxxxx
>mrouter -c connect-device -d SJC xxxxxxxxx

To disconnect from the smartphone, type
>mrouter -c disconnect-device -d<Bluetooth device name>

You can also type
>mrouter -c disconnect-device -d.
   where a period stands for the currently connected device or the first connected device if more than one device is currently connected.
   1.3.2 mrcmd—Controlling the Phone from the PC

mrcmd is a PC side program that allows you to run pipe processors and scripts on the smartphone. Before running pipe processors and scripts on the smartphone it is necessary to set up the requisite level of security for your mrix setup. This is done by setting the mrcmd environment variable. At present, identity configuration information is stored in the \system\mrix\identity.ini file on the smartphone. A CTO identity has been set up in this file with a password of GOOD. You should use this identity for playing with the mrix system. This can be done from the DOS command shell as follows:
>set mrcmd=-i CTO -a GOOD

Alternatively you may wish to set this permanently thus:
Right click on ‘My Computer’ on your desktop and select ‘Properties’.
Select the ‘Advanced’ tab.
Click the ‘Environment Variables’ button.
Click the ‘New’ button in the ‘System variables’ list.
Enter ‘MRCMD’ into the ‘Variable’ field and ‘-i CTO -a GOOD’ into the ‘Variable Value’ field.
Click OK three times to save the change.

Once security has been set up, you will need to start up the remote shell daemon, rshd, on the smartphone. You should only have to do this once the first time you run mrix on the smartphone. Thereafter, rshd will be automatically started at boot using the mrix boot server. To run rshd, you need to open the mrix application on the smartphone and execute the first command in the list box which should be:
mrtcp
   -accept --local 3011 --run “rshd --run”

The mrix application is a simple way of running commands and scripts on the smartphone. To invoke another command from mrix just simply overwrite an existing command line (and any necessary parameters).

Now you are ready to try running an mrix command using mrcmd over an existing mRouter connection. You may try out any of the wide range of existing pipe processors; mrps and mrfile will be described here.

Connect to the smartphone using m-Router.

To view all the processes running on the smartphone, type
>mrcmd. “mrps −1”

mrcmd tells the smartphone (in this case denoted by a period which means the currently connected device but you can be explicit and specify the Bluetooth name) to run the mrps pipe processor with the −1 option. Notice that the command is enclosed in double quotes.

To get help on mrps from the command line, type
>mrcmd.“mrps -h”

To send a file to the smartphone, type
>mrcmd.“mrfile -w c:\system\default.car”<c:\mrix\bin\default.car

This command redirects a file (c:\mrix\bin\default.car) to the smartphone. The ‘-w’ option specifies where on the smartphone the file should be written (c:\system\default.car).

To delete the file from the smartphone type
>mrcmd.“mrfile -d c:\system\default.car”

To get help on mrfile from the command line type
>mrcmd.“mrfile -h”

Lua scripts can also be invoked using mrcmd. To get help on running lua scripts from the command line, type
>mrcmd.“luarun -h”

Create a script file called test.lua and copy and paste the text between (and not including) the chevrons to the file

>>>>>>>>>>>>>>>>>>>>
#!luarun
mrix.write(“Hello, World!\n”)
-- run the mrprompt pipe processor
-- mrix.run runs other scripts and pipe processors and has the form
-- mrix.run(command, command parameters, [optional input])
res = mrix.run(“mrprompt”, “-t YESNO -p \“Need help?\””)
mrix.write(“Result = “..res..”\n”)
>>>>>>>>>>>>>>>>>>>>

Lua scripts can be run on the smartphone in one of two ways:
by streaming a lua script to the smartphone
by running a lua script that resides on the smartphone.

To stream the script to the smartphone, type
>mrcmd.“luarun -”<test.lua

The script will print, “Hello, World!” at the command line. By this method the script does not have to be resident on the smartphone.

To run the script from the smartphone, first write the script to it.
>mrcmd.“mrfile -w c:\system\mrix\test.lua”<test.lua

To run the script, type
>mrcmd. “luarun c:\system\mrix\test.lua”

The result is the same as running the script by the first method.

Lua can be invoked interactively as in the following example thus:

>mrcmd . “luarun”
>mrix.write(“Hello, World!”)
>q

For help on lua, check out the following resources: http://www.lua.org, http://lua-users.org/wiki/TutorialDirectory. Review Intuwave's extensions to lua in the mrix documentation.

1.3.3 More on Scripts

There are two ways to run a lua script on a smartphone independent of interaction with a PC.

The first is to invoke it using the mrix application. Simply type the name of the script in the Cmd field and any parameters for the script in the Params field and select Run.

The second is to have the script run when the smartphone is turned on. To do this you have to setup an event that loads the script into the boot file of the smartphone:
>mrcmd.“mrevent -a -n runmyscript -e BOOT -c luascript.lua”

This command adds (-a) a boot command (-e BOOT) to the boot file of the smartphone to run a script (-c luascript.lua) when the smartphone is turned on. The event is given a name (-n runmyscript) that acts as a handle such that it can be removed from the boot file thus:
>mrcmd.“mrevent -d -n runmyscript”
   1.3.4 Identities

All mrix smartphone scripts and pipe processors are run, whether locally or remotely, under the permission of an identity. An identity consists of a username, password and a set of permissions governing which scripts and pipe processors may be run under that identity. The identity file, identity.ini, is located in the \system\mrix directory on a smartphone.

So far we have run commands via mrcmd using the user, CTO (which has full permissions for all commands). If a smartphone is setup to run a script when it boots then the default identity it will use will be “Guest” which has minimal permissions. The script will therefore be limited in the mrix commands that may be run. To do anything useful the identity must change so that the script may take on more permissions. Edit the lua script file you created earlier. Copy and paste the text between (and not including) the chevrons to the file. Then use mrfile to send the script to the smartphone and run it using the mrix application. In mix select Options|Run, enter “test.lua” into the Cmd field (make sure the Params field blank) and select Run. You will be presented with a prompt to which you may select yes or no.

>>>>>>>>>>>>>>>>>>>>>>>
#!luarun
-- save the current identity, in this case, Guest
old_id = mrix.getcurrentidentity( )
-- make a new identity handle using the CTO username
new_id = mrix.makenewidentity(“CTO”, “GOOD”)
-- use this newly created identity to run the following commands
mrix.setcurrentidentity(new_id)
mrix.write(“hello, world!\n”)
-- run the mrprompt pipe processor
-- mrix.run runs other scripts and pipe processors and has the form
-- mrix.run(command, command parameters, [optional input])
res = mrix.run(“mrprompt”, “-t YESNO -p \“Need help?\””)
mrix.write(“Result = “..res..”\n”);
-- restore the saved identity
mrix.setcurrentidentity(old_id)
-- release the new identity to free up resources
mrix.releaseidentity(new_id)
>>>>>>>>>>>>>>>>>>>>>>>

Appendix 2
Mrix 2.0 Kernel Internals
2 Introduction

The mrix v2 kernel runs as a Symbian ‘server’ in its own process/thread. Clients make calls to the kernel via MrixClient. The kernel itself is made of smaller modules. Basic primitive objects are contained in a module called MrixKernelObjects such as pipes, bundles, string and links. Another module MrixKernelIdentity builds on these classes to provide identity/policy services. A Third module MrixKernelTasks adds the ability to create and run tasks provided by dlls, exes and scripts. Finally MrixKernel implements the actual Symbian server and session classes that drive and co-ordinate the afore mentioned modules. All these modules are currently dlls. A small stub executable (MrixKernelLoader) loads these dlls and runs them in its process space. In a MUCH future versions of the kernel all these modules may need to be combined into a single executable to prevent the individual dlls being subverted. Much of the security of the kernel is a result of combining various classes. To some degree the whole picture may only become clear when all the modules are understood, HOWEVER it should be possible to understand the role each module plays individually. Hopefully this will allow maintenance of the various parts with minimal if any impact on other parts (keeping the exported API's the same where possible.

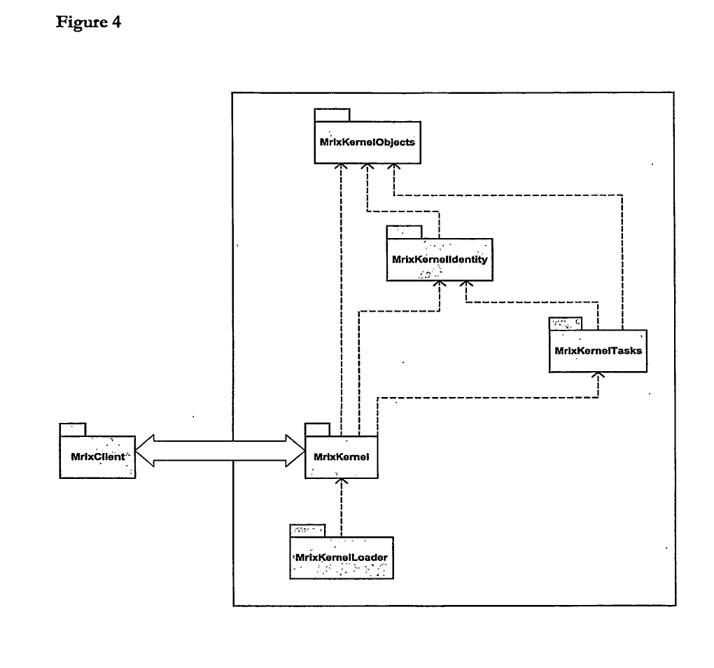

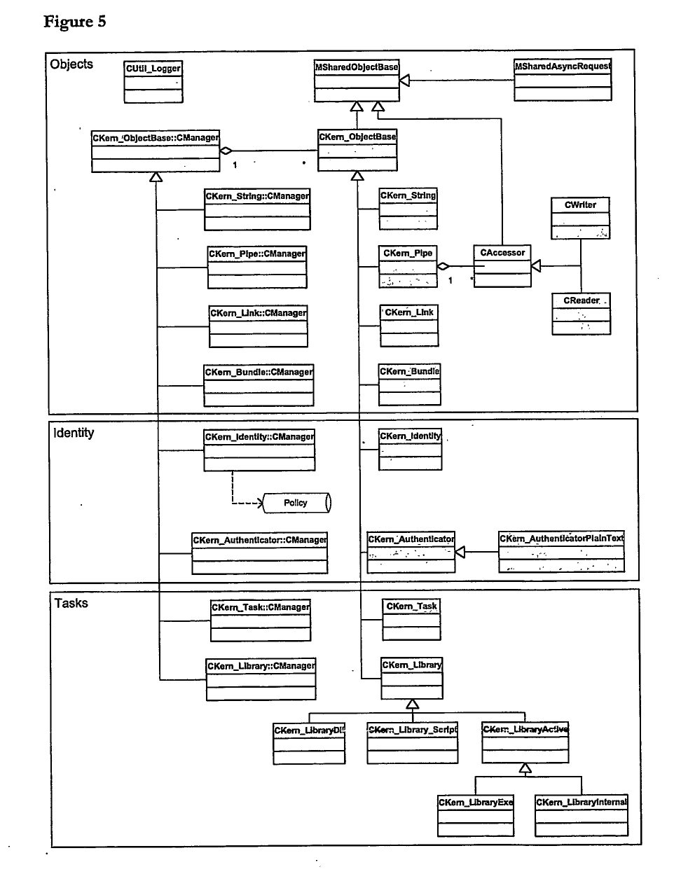

The class structure of the kernel (see FIG. 4) at first glance may seem complicated but it is built on recurring patterns and layers so that (hopefully) it is simpler than expected. A Portion of, this class structure is shown at FIG. 5.

3 MrixKernelObjects.dll

With the exception of a utility class ‘CUtil_Logger’ that provides text file logging functionality, most of the classes are derived from or related to an abstract MSharedObjectBase class.

3.1 Base Classes

A default implementation of the MSharedObjectBase class is provided by Ckern_ObjectBase. This has a related factory class nested inside it called CManager.

Other classes are derived from these classes to provide a repeating implementation pattern. CKern_ObjectBase provides reference counting methods however when a reference count reaches 0 the object is NOT deleted immediately, but rather an active object in the manager class asynchronously garbage collects all null objects. There are a few advantages in this delayed deletion.
Classes such as Strings which reach a reference count of zero can be looked up and ‘rescued’ and their reference count incremented if they are required before they are actually deleted.
Since deletions are done asynchronously if a pointer to an object valid at the start of a function it will still be valid at the end of that function even if it is released by some function called during the execution of that function. This was a cause of some access violations in mstream and while it is possible to code such as to avoid such problems (and this was done in some places) the code then looks slightly more complicated. This scheme side steps the problem by ensuring it doesn't happen in the first place. It also simplifys problems with circulare dependencies. When an object is released it releases the objects it references. Rather than being deleted immediately (and thus potentially causing coding problems) the object is deleted later AFTER this object has fully detached itself and been deleted.
Calls into the kernel can execute faster since memory release and compaction are handled at idle time rather than in the context of a synchronous client initiated operation.
It avoids some calls to the cleanup stack on object creation. Traditionally one pushes new objects onto the cleanup stack liberally knowing that they will be deleted if some method leaves. One aspect of the delayed reference counting scheme is that objects are created with reference count of zero. Unless something takes (partial) ownership of an object then it is later garbage collected. While the cleanup stack and trap harnesses are a GREAT thing they do incur some measurable performance overhead and so they are only used where NEEDED.

The Factory/Child pattern is taken advantages in several derived classes. For example the manager for CKern_String arranges its children in an ordered list and allows lookups on that list—providing a sharable dictionary of strings. One advantage of this is that common strings such as “c:\systemlibs\mrix\mrFile.dll” and “Guest” etc are stored ONCE and shared between interested classes. In another example The CKern_Link manager allows all the objects used by a session to be tracked and validated (more on this later).

Some classes in other modules such as CKern_Library and CKern_Authenticator themselves are further derived from to provide more specialized classes. At present these sub classes (library types and authenticator) types are part of the kernel. Mechanisms COULD be added to the kernel to allow external or third party subclasses though this obviously has security implications (third party code loaded into the kernel memory address space)

Some operations provided by classes are by nature asynchronous. An abstract base class MSharedAsyncRequest is used to encapsulate such operations. A CancelRequest virtual method allows cancelling of such requests.

Every instance of a MSharedObjectBase derived class has a ‘Handle’ that uniquely identifies that object in the kernel. At present this handle is actually the ‘this’ pointer (since its unique) but this should NOT be assumed as it may well change in future versions of the kernel for security reasons. If a Handle is known a CManager can be used to search for an instance with that matching handle. Thus we DON'T cast handles to pointer only pointers to handles. Having said that, CKern_Link objects mentioned below delegate to the object that they aggregate for this Handle( ) value.

The objects owned by a CManager derived object can be iterated by using a templated iterator. This steps through all the owned objects and for each attempts to provide the requested interface. the iterator silently steps onto the next object if that interface is not available. There is NO CASTING OF HANDLES TO POINTERS.

Objects may be shared by different parts of the kernel, and thus can be shared by clients of the kernel by reference to handles. This exposure and sharing of objects by their handles is performed by MrixKernel.dll using flags (access rights bits) provided by CKern_Link objects implemented in MrixKernelObjects.

3.2 Object Classes

This section briefly explains the purpose and aspects of the primitive classes provided by MrixKernelObjects.

3.2.1 Pipes

Pipes are binary byte FIFOs. A pipe has 2 ends. The ends are a reader end and a writer end. Bytes written into the writer end are buffered inside the pipe to a certain amount. These bytes can then be read out of the pipe in the same order in which they were written. The writer can ‘close’ the pipe. This means that no more data is allowed to be written into that pipe. Bytes can still be read out of the closed pipe until the pipe is empty at which point the reader will return an error (EOF).

As data is written into the pipe a count is kept of the bytes written into it, conceptually this is the length of the pipe. When a pipe is closed a reader can retrieve this value and thus knowing how much it has already read how much data it has left to read. The writer CAN specify this ‘pipe length’ in advance for example if spooling a file of known length. It is then not allowed to write more than that amount of data in total to the pipe. (at the point at which that ‘length’ is reached the pipe is automatically closed). If the reader requests the length of a pipe before it is unknown then the value −1 is returned.

This pipe length is NOT the amount of data the implementation of pipe may buffer inside it. The amount a pipe could buffer internally used to be 4K, it is now 256 bytes however clients should not assume any buffering size. Reducing the buffering size for pipes means that the memory per pipe (and effectively the mrix kernel) is 1/16^{th} of what it was previously. As the buffer size is reduced more IPC calls are needed to transfer the data in smaller chunks and this adds delay. 256 bytes seems to be a reasonable figure that is ‘fast enough’ while not eating up ‘too much memory’. Currently the circular buffers for pipes is allocated from the heap of the kernel, while such buffers are smaller a future improvement would be to use ‘Chunks’ these are memory allocations provided by Symbian taken from a global memory pool rather than the heap of the mrix kernel.

The implementation of the class uses MSharedAsyncRequest objects to read and write data from a circular buffer. An example might make some sense as to how this works. A client might make a request to write 16K of data into the writer end of a pipe. The pipe implementation fills as much of its 256 byte circular buffer with data from the client BUT DOES NOT COMPLETE THE CLIENT CALL YET. Either before or after this time another client may try and read 8K of data from the pipe. The pipe will write as much as it can (256 bytes in this case) to the reading client. BUT DOES NOT COMPLETE THE CLIENT CALL YET. It then checks if it can refill its circular buffer from any writing clients which in this case it can and another 256 bytes is read from the writing client into the circular buffer. It then writes this out to the reading client, it repeats this loop until either the writer has no more data to transfer or the reader client's buffer is full. In this case the reader client buffer will fill first and at THAT point its asynchronous call is completed. It may make another call to read a further 16K of data and eventually the writer data will be consumed. At which point the client asynchronous call is completed. The pipe code basically shuttles data between 2 clients (processes/threads). It can do this relatively easily and fast as it does not need to context switch for each 256 byte chunk. Context switches are BAD (ie they take time and slow things down) so avoiding them is usually a good idea. Reading clients CAN request that they read ‘one or more’ in which case the pipe object will complete the reading asynchronous call when it has transferred as much data as it can (ie if the circular buffer has become empty and it has transferred SOME data to the reader).

Clients can cancel requests in which case they are completed immediately. Adding requests or removing requests from the reader or writer ends of a pipe trigger an asynchronous ‘kick’ of the pipe transfer engine so even if the engine stalls (which it never does/should) it will be restarted when the next request is made/cancelled.

Since pipes are byte streams they cannot transfer Unicode strings as is. There is an encoding of Unicode text known as UTF8 (a nice feature of which is that western characters are still readable) and the kernel is able to accept Unicode data and convert it to utf8 and then write that into the pipe. It does this in chunks to keep memory overheads down.

3.2.2 Strings

Most programs use strings but these can be for different reasons. Some times the strings are programmatic things like filenames or field names, other times they may be user interface messages. Sometimes the strings may be 8 bit and other times they may be 16 bit. Using 16 bit strings obviously use twice as much memory as 8 bit strings and so they should be used appropriately. All that said strings are useful things and often they are passed in and out of the kernel. In many cases a string may be heavily re-used. For example strings like “mrStorage” and “-list THING -option SOMETHING.” may be used repeatedly. If the kernel kept duplicates of such strings internally it could soon run out of memory. To reduce the amount of memory required the kernel converts strings to pointers to shared String objects. The CManager class for CKern_String orders all strings in an array. Strings are searched for using a binary chop technique so if there are say 1024 strings inside the kernel it only takes 10 string comparisons worse case scenario to find the matching string. Once this is done string objects be compared (case sensitively) by comparing the 32 bit pointer to the object. This is fast.

Strings can be (and are often) returned to clients by specifying the string ‘handle’. The client can then fetch the contents or enquire if they wish as to the length of the contents. The kernel converts Unicode strings to UTF8 equivalents so a client may request data in either format. Passing a string across thread boundaries has ‘some’ overhead over and above passing a handle in a IPC request. Thus a client CAN speed itself up by passing string handles instead of strings, however it may do this at the expense of source code readability.

3.2.3 Bundles

“Bundles are poor misunderstood creatures. Give them a chance and thy will be nice to you at Christmas.”

Bundles are a data structure heavily reused used inside the kernel to provide name value pair lists. Internally a list is kept of string object pairs. There can be multiple entries in the list with the same value. Methods exist to add/replace/remove values based on a string key value. Keys are case sensitive.

Each pair has a 32 bit flag word associated with it. This is used by MrixKernel to control access to clients. (more on this later). Bundles can be shared between clients and can be watched for changes. That is a client can make an asynchronous request to ‘watch’ a bundle. When that bundle is changed (values changed, items deleted, removed) then all clients watching that bundle are signalled. The client can then resubmit their watch request and query the bundle for values. IN THAT ORDER TO AVOID RACE CONDITIONS.

3.2.4 Links

CKern_Link objects contain pointers to other objects. They expose a 32 bit flag word and aggregate the object they point to. The CKern_Link implementation overrides Handle( ) and GetExtensionInterface( ) to delegate to the aggregated object

Each client session (later described) has an associated CKern_Link::CManager instance that owns all the ‘links’ used by that session. When a session passed in a handle to an object it is validated against the list of objects ‘known’ to that session. In reality this checks they are in the CManager instance for that session. At the same time the type and access rights (i.e. the 32 bit flag word) are checked for the operation the client is requesting. When a session is released so are ALL the links owned by that session (via the CManager object). A session may have multiple reference counts on a link but this only equates to one reference count on the aggregated object.

4 MrixKernelIdentities.dll

4.1 Identities

Conceptually all actions are done by an identity and act on a resource owned by (usually another) identity. An identity might be a human being, a remote automated process, an application, a authenticated script. An identity has some unique NAME that can be used programmatically to distinguish an identity. An identity may also have other human readable names or descriptions, but essentially an identity is a named ‘actor’. When an identity is referenced there is always a degree of certainty/uncertainty that the identity is REALLY the identity claimed to be. In real life how can a person prove that they are who they claim to be?

When an identity acts on another identity's resources there is some policy as to what is permitted and how things should behave. In the kernel the identity owning the resource is called the CONTEXT identity. Thus an identity such as CTO may act on resources in the context of mrFile. Unless a client explicitly sets its context then a shared global context is used.

Each library (explained below) has an identity, currently this identity is autogenerated based on the name of the library, but in the future this identity might better be obtained as a result of signing the library with a digital signature.

There are some special ‘stock object’ identities that can be requested.
Guest—an identity used by default for un negotiated external peers
DefaulltUserIdentity—an identity used by user interfaces and other ‘local’ modules that has ‘full’ permission. In the future it is possible that this identity will be come a (changeable) alias for another identity. It is also likely that in the future the default user identity may not have complete admin rights to the device, but in this version it does. It is also possible that Applications and code requesting and using this identity may need to be signed or authenticate themselves via some pin code entry. (this has obvious user interface considerations)
SharedGlobalContext—This is the context shared by all scripts and all ‘mr’ libraries unless they explicitly specify another context to use.

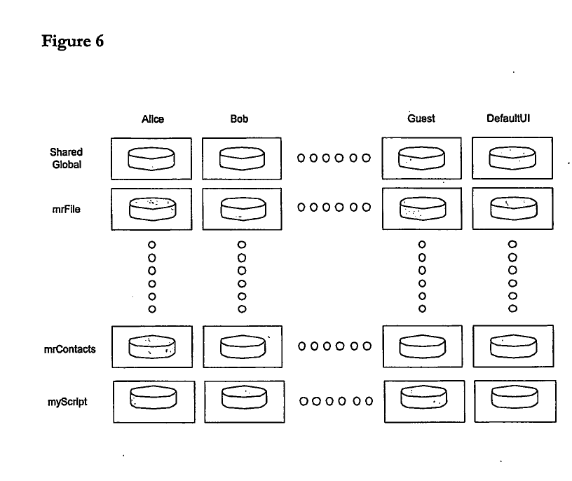

One can imagine a matrix of separate policy/permission stores, as shown in FIG. 6. Within each store are name value pairs (implemented currently as bundles) however there is nothing to stop such policy stores from being stored as expressions or other binary data. What is important is to recognize that there are such logical policy/permission stores/databases.

Though not shown in FIG. 6, any identity can appear on either axis. The policy for a given pair of identity and context may be null. In the implementation of this kernel the policy consists of name value pairs but again this might change/evolve (if NEEDED) In the kernel the CKern_Identity class encapsulates a named identity and the degree of confidence that the identity is genuine. There are no policies or permissions owned or contained within that class. Rather the CManager class can be querried for such information.

Remember though the identity manager is itself a resource and thus whether or not it actually allows read or write permissions to identity data depends on the identity of the person asking for this data. Ie the following situations arise.
Requesting Identity A wants to know what some setting for identity B is in the context of identity C
   Or
Requesting Identity A wants to modify the setting for identity B in the context of identity C

The CManager class exposes functions therefore that allow such queries.

Clients can set the context identity (‘C’ above) and (should) be able to set the requesting identity (‘A’ above).

The Identity manager currently enforces the following policy
Only the DefaultUserIdentity is allowed to request changes to policies.
The DefaultUserIdentity is allowed to run any task/library

Currently all the ‘mr’ libraries do NOT set the context to be their own identity and so default to the GlobalSharedContext Identity. The downside of this is that the names of settings for say ‘mrFile’ cannot conflict with the settings of say ‘mrContacts’.

In the future removing an identity (such as a user or a library) might also delete the policies involving that identity (else a device might fill up over time with old unused policies)

In the current kernel the policy information is held in memory as a bundle and read in once from a text file identity.ini at startup, it is (given the rearchitecting) possible for code to be trivially added to save and restore this data from a binary file. In the future such policy data could be stored in a Symbian database. In a future version of the kernel a portion of this policy data might even be stored in a SIM (smart card)

4.2 Authenticators

Identity objects can be obtained by name, however ideally they are obtained as a result of some authentication process. The actual mechanism for authenticating a user is independent of the identity itself and how it is used. The CKern_Authenticator class and its derived classes can be used with a sequence of challenges and responses to negotiate a peer identity.

The method of performing an authentication be it plain text or MD5 hash or certificate/signature challenge is independent of how the challenges and responses are transferred. In some cases there may be no challenge, for example in the plain text authentication as used by rshd there is a challenge that is zero bytes long [symbol] . Having the authenticators inside the kernel mean that can access privileged identity data not available outside of the kernel (ie passwords). In some future versions of the kernel the authenticators MIGHT use the SIM (smart card) to perform some aspect of the authentication.

Currently the only implemented authenticator is a Plain Text Username Password authenticator.

Obviously negotiations may be incoming, outgoing or symmetric. When creating an authenticator one can specify the local identity to present to the peer. And after a (successful) negotiation a CKern_Identity object representing the peer (which includes a confidence level) is obtainable from the authenticator object.

5 MrixKernelTasks.dll

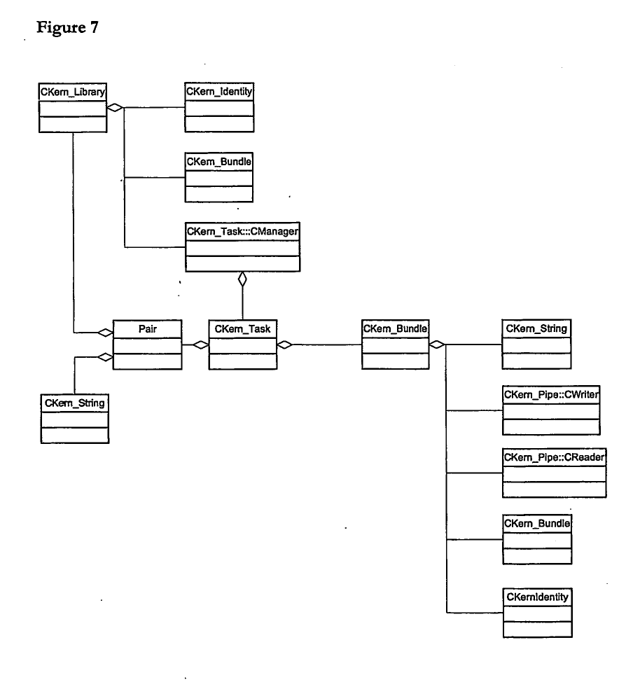

This module builds on previous modules and classes to allow the execution of tasks. These tasks are executed inside libraries (historically called pipe processors). These libraries may be implemented in arrange of ways from polymorphic DLLS to executables to scripts. FIG. 7 illustrates it.

5.1 Tasks

A CKern_Task object has a state that is one of
constructed,
starting,
running,
   stopped (with a result code)

It contains a number of properties (implemented internally as a bundle) including an identity, input and output pipes and input and output environments. A task also has AT LEAST ONE library and command line pair associated with it. In the case of a script there may be more than one pair. For example a task might have the pair “myScript.lua” and “-run thing” but it ALSO has the pair “lua5.exe” and “myScript.lua -run thing”. (in fact the library's are pointers to CKern_Library instances so a task has access to the identities of the libraries it is executing within as well as the identity it is executed BY.

A client creates a task at which point various system resources are allocated. Then the task is started. Internally this actually marks the task object as startable; at some point a library will service this task and stop/complete the task with some exit code. The client that created the task may asynchronously wait for the task to start and or exit.

When executing a task the identity that is passed in to execute as must be one of
a stock identity
an identity retrieved INSIDE a library for itself
an authenticated identity
   ie you cant just claim to be the CTO identity, when running a task you have to prove it. (even if by a known password)
   5.2 Libraries

A library has a queue of tasks (implemented as a CKern_Task::CManager). Depending on the implementation of the derived class, the library will execute code in process or out of process which processes that task.

In the case of polymorphic dlls this involves loading that dll in a worker thread. The polymorphic dll requests tasks from the kernel. The Kernel associates the worker thread with the library that created it and passes it tasks to execute when requested. If the thread dies unexpectedly any tasks running in that thread are marked as ‘stopped’. If the thread dies BEFORE a task is started then an unrun task is marked as stopped, this means if a BAD library constantly leaves in its constructor then successive tasks will be marked as stopped (with their result codes being set to the exit code of the thread). If it did not do this then it might be able (as it did in a previous version of the kernel) be possible for the kernel to get stuck in a fast loop constantly trying to load a library and failing.

In the case of executables, currently the derived library class creates an active object for each running task. That active object starts an instance of that executable. The executable makes requests to the kernel for its ‘task’ and the kernel matches up the client thread/process to the correct library object and active object. If the executable exits without setting the task as completed/stopped then the active object detects this fact and sets the task as completed with the exit code of that executable.

Scripts are handled by their libraries internally delegating the execution to another library which in turn may delegate again until it is handled by a library or an error occurs.

Finally there is an as yet unused library class which runs INSIDE the kernel—it provides a hard coded/built in command MrixKernelCmd that can be used to administer identities and permissions. It could have been written as an external command but then it would have been necessary to expose internbal interfaces used by this library. MrixKernelCmd is currently unfinished/untested but it should be trivial to complete at which point the user will be able to administer permissions and policies in a secure way. All libraries appear to behave the same to clients.

Each library has an associate identity, currently this identity is auto generated based on the library name, however in the future this identity might be supplied as a result of signing the library binary with some certificate.

Each library also has an ‘info’ bundle associated with it. Currently this bundle is empty, but in the future it might have auto generated data. Alternatively in the future this bundle might be securely populated by supplying some meta data file with a library. Such library data ‘might’ in the future include
Copyright
Version
Resource strings
Licence information
Author/Credentials for library execution
URL to get updates from
   6 MrixKernel.dll

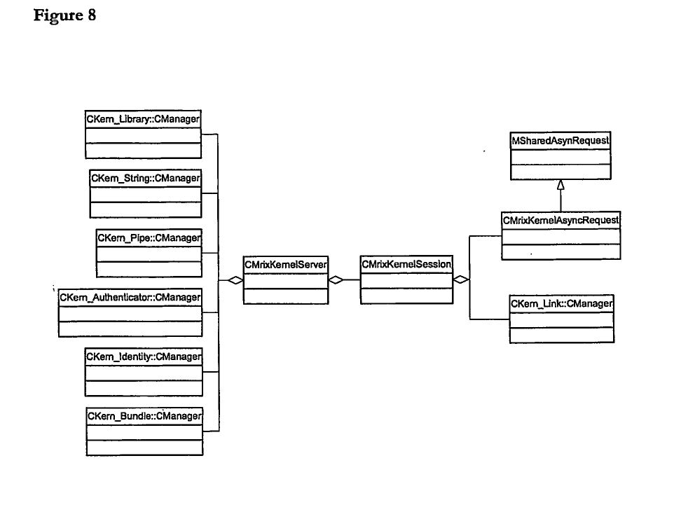

This is the module that pulls everything together to create the kernel; it is shown in FIG. 8. When the module loads it creates a CServer derived class. Clients can then request a CSession derived class.

Note that because of the changes in Symbian IPC API's various mechanisms of IPC are abstracted. For example to get the second argument of a message one can use the function Int32(aMessage,2) etc. This moves the conditional compilation of code to a single part of the module.

The CMrixKernelServer creates and owns several managers.

CKern_String:CManager—this is the ‘dictionary’ of ALL strings shared inside the kernel. CKern_Bundle::CManager and CKern_Pipe::CManager are used as factories when clients need bundles ore pipes created.

CKern_Identity::CManager acts as a factory for identity objects and also as the object that is queried for policies for those identities.

CKern_Authenticator::CManager creates authenticator objects of the requested type. The manager is initialised with a reference to the Identity manager so that it can access password information and get and ‘return’ identities.

CKern_Library::CManager is responsible for finding/loading/unloading library derived classes.

At server construction these managers are used to create several stock objects (ie guest identity, null pipes etc)

Each client creates at least one session derived class. The CMrixKernelSession class handles requests from the client. Each session object owns an instance of a CKern_Link::CManager class. As objects are created and handle reference returned to the client a link object is added (or reused) that includes the permissions granted to the use of that link. When a client makes a request and passes in a handle value the session object uses the link manager to validate that handle. It also checks that the link has the right flags (bits) set for the requested operation. If the request is asynchronous then it creates an instance of (derived from) to handle that request. For example . . .

case EOpWritePipe:

{
iLinks−>LogLine8(NULL,“WritePipe”);
CKern_Pipe::CWriter
CKern_Link *link=
GetObjectL(aMessage,0,CKern_Pipe::CWriter::ETypeUid,(TAny**)&pWriter,mrix::K

CanWrite);

CMrixKernelAsyncRequest

*req=NewRequestLC(EOpWritePipe,aMessage,3,Length(aMessage,3));

req−>AddLinkL(link);
pWriter−>QueueWriteL(req,Length(aMessage,3),Int32(aMessage,1));
CleanupStack::PopAndDestroy( );//req now owned by writer
break;
}

This code fragment . . .
Logs the function being called,
Gets the object matching the handle passed in the 0^{th} parameter of the message, checks that it is of type CKern_Pipe::CWriter and that the link for that object owned by this session includes the mrix::KCanWrite flag. If any condition is not satisfied the method leaves with KErrAccessDenied.
Creates a request object that will use the client buffer identified by the 3^{rd} argument of the message
Associates the link with that request and then
Calls the method on the writer object that will complete asynchronously
Destroys the reference this code was holding on the cleanup stack since the writer has taken a reference count and now ‘owns’ that request
   6.1 Handles and Sharing

As mentioned each session maintains a list of known objects (via link objects) and has permission flags for these objects. Other than creating objects, clients can also obtain handles to objects if they are explicitly shared by another client. For example if client A has a handle to a pipe, client B cannot use that handle value until client A explicitly shares that value to client B by specifying its session id. (each client session has a unique id). Also passing an object into a task or a bundle means that if the task handle is transferred to another client (as part of running a task) then the rights to the objects contained in that task are ALSO transferred.

6.2 Logging

The mrix kernel DOES include some powerful debugging logging—possibly too powerful and so it is only compiled into the debug kernel by default. By creating a directory called c:\logs\mrixKernel periodically the kernel will domp out all the objects it has in memory including binary pipe data and otherwise secure data. Ie its ok for now for debugging inside Intawave on an emulator but don't ever let that code out into the big wide world as it defeats the point of kernel security. Also in the debug build components log as a result of base classes: For example for mrFile if one creates a directory called c:\logs\mrFile then each client instance will log all calls made, the results and all data transferred. The following is an example.

This is a LOT of debugging but a FULL dump of all the clients interaction with the kernel—it is more useful for debugging the kernel but internally we might also use it when ‘mr’ libraries need debugging.

7 MrixClient.dll

This class which exposes the client interface of the kernel is best described in a separate document aimed at users of mrix. It attempts to connect to the kernel, where necessary starting it (using MrixKernelLoader.exe on a device) and then provides various functions that the user can use to access a range or mrix functions.

1. A method of controlling access to a specific resource on a mobile telephone; comprising the steps of:
(a) associating an identity with a permission state, in which an identity is a label applicable to one of several entities on whose behalf the resource could potentially be used and the permission state defines whether or not the resource can actually be used; and
(b) allowing use of the resource solely to an entity or entities labelled with an identity associated with a permission state that does permit such use.

2. The method of claim 1 comprising the steps of
(a) a script or other kind of executable code associated with a given entity sending a request to use the specific resource; the script being labelled with an identity or including a secure signature from which an identity can be deduced;
(b) a software component running on the device processing the request and using the identity to determine the applicable permission state associated with the identity for that script or executable code.

3. The method of claim 1 in which the permission state includes a permission type and a value.

4. The method of claim 1 in which a permission state associated with a given identity can be updated or altered.

5. The method of claim 4 in which the updating or alteration of a permission state is done on instructions sent from a computer remote from the mobile telephone.

6. The method of claim 1 in which use of the resource includes one or more of: access, deployment, alteration or deletion.

7. The method of claim 2 in which the script or other kind of executable code associated with a given entity is labelled with an additional identity separate from or independent of the identity of the given entity; the additional label identifying the script or code.

8. The method of claim 7 in which the component can use the permission state associated with the additional identity to enable it to determine if the script itself is permitted to use the resource, irrespective of whether the given entity is allowed to use the resource.

9. The method of claim 2 in which the script or code can have its identity altered.

10. The method of claim 9 in which the alteration is a result of instructions sent to the telephone from a remote computer.

11. The method of claim 9 in which the identity is altered to an identity associated with a higher or broader permission state only if the script or code has been authenticated to a pre-defined confidence level.

12. The method of claim 2 in which the method is deployed on the mobile telephone by a component that is not part of the operating system and can therefore be installed onto the telephone without needing to be burnt into the main ROM of the telephone that stores the operating system.

13. The method of claim 12 in which the component runs in the secure SIM of the mobile telephone.

14. The method of claim 12 in which the permission states and their association with different identities are stored in the SIM, but the component runs outside the SIM.

15. The method of claim 14 further comprising the step of remotely administering the permission states associated with different identities, by sending instructions from a computer remote from the computer.

16. The method of claim 2 in which the component stores in memory, or accesses from memory a list of the permission states associated with different identities.

17. The method of claim 2 in which an identity is determined for any script that seeks to access code by an authentication process using a digital signature.

18. The method of claim 17 in which the authentication process generates an identity handle that can be transferred as a token.

19. The method of claim 18 in which the identity handle has an associated confidence level based on the authentication.

20. The method of claim 1 in which the entity is an individual end-user.

21. The method of claim 1 in which the entity is a network operator.

22. The method of claim 1 in which the entity is a mobile telephone manufacturer.

23. The method of claim 1 in which the entity is an application developer or vendor.

24. The method of claim 1 in which the entity is an employer.

25. The method of claim 1 in which the entity is an operation

26. The method of claim 25 in which the operation is booting the telephone so that startup code is run, the startup code having a specific identity, and the permissions for this identity determine what can or cannot be done at startup.

27. The method of claim 1 in which the entity is an operation of a timer going off.

28. The method of claim 1 in which the entity is a kind or type of entity.

29. The method of claim 1 in which at least two entities do not have identities that are associated with permission states that are hierarchically arranged with respect to each other.

30. The method of claim 1 in which no entities have identities that are associated with permission states that are hierarchically arranged with respect to each other.

31. The method of claim 1 in which no entity automatically has rights to use all resources on the telephone.

32. The method of claim 1 in which the resource is specific data.

33. The method of claim 32 in which the permission state determines whether the data can be read, modified or deleted.

34. The method of claim 1 in which the resource is a specific executable application and the permission state determines whether the application can be run or updated.

35. The method of claim 1 in which the resource is a hardware resource on the telephone.

36. The method of claim 1 in which the resource is a networking or communications resource on the telephone.

37. The method of claim 1 in which the step of associating an identity with a permission state results in a record of the association stored in a memory of the telephone.

38. The method of claim 1 in which the step of allowing use of the resource takes place by a CPU in the telephone processing data.

39. A mobile telephone with specific resources, in which access to the resources is controlled using the method of claim 1.
